(19) United States
(12) Patent Application Publication
(10) Pub. No.: US 2009/0319309 A1
(43) Pub. Date: Dec. 24, 2009

(54) PAVEMENT MANAGEMENT SYSTEM

(76) Inventor: Robert M. Shanteau, Seaside, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/141,874

(22) Filed: Jun. 18, 2008

(51) Int. Cl. G06Q 10/00

(52) U.S. Cl. 705/7

(57) ABSTRACT

A system and method for analyzing and minimizing the life-cycle cost of constructing, maintaining and rehabilitating a network of highway pavements for a pre-determined life-cycle and associated range of minimum acceptable conditions thereof. Specifically, the present invention enables a decision maker to realize the trade-off between cost and pavement condition, thereby aiding the decision maker in choosing an appropriate allocation of resources for pavement construction, maintenance and rehabilitation.

### TECHNICAL FIELD

The present invention relates to an analysis system for minimizing the life-cycle cost of building, rehabilitating and maintaining a network of highway pavements, commonly referred to as a pavement management system (PMS).

### BACKGROUND ART

Life-cycle cost analysis (LCCA) is commonly used in the selection of maintenance and rehabilitation (M&R) activities of individual highway segments. The objective is to find the set of construction and M&R activities that minimize the long term discounted cost of a pavement segment given a minimum acceptable pavement condition (often called a trigger level).

Customary approaches to pavement management, however, take a different approach. They attempt to find the set of construction and M&R activities for all pavements in a network that maximize some function of pavement condition subject to a maximum budget constraint. This is a very difficult problem that must be solved with sophisticated optimization techniques such as integer programming, dynamic programming, or genetic programming. Furthermore, there are several issues with this approach: (1) the set of construction and M&R activities found from the pavement management system (PMS) are not guaranteed to correspond with the construction and M&R activities found using LCCA for each individual segment; (2) decision making using the PMS process is centralized whereas decision making in most or all state departments of transportation (DOTs) is distributed among many districts; (3) a massive amount of data on pavement condition, deterioration rates, and costs must be maintained and kept current by the PMS; and (4) the results of the PMS are the optimum set of activities for the pavement network, whereas decision makers are more interested in the trade-off between network pavement condition and costs.

### DISCLOSURE OF THE INVENTION

The invention takes advantage of a newly discovered fact that, under an easily met condition, the solution to the problem of finding the least life-cycle cost of managing a network of pavements is the same as the solution to finding the least life-cycle cost of managing each segment in the network individually. The condition is in fact one of the conditions used to solve the customary PMS problem. It simply requires that the life-cycle cost of managing any pavement segment is independent of the life-cycle cost of maintaining any other pavement segment in the network.

To be specific, the following description is for a network of pavement segments. But the invention is not limited to highway pavements. It can be extended to any set of objects (bridges, pipelines, oil platforms, ships, trucks, locomotives, buildings, etc.) for which a condition can be defined and for which the life-cycle cost of managing each member of the set is independent of the life-cycle cost of maintaining any other member of the set.

An analysis method for minimizing the life-cycle cost of constructing, maintaining and rehabilitating a network of highway pavements for a pre-determined life-cycle and associated range of minimum acceptable pavement conditions thereof, commonly referred to as a pavement management system, comprises steps for: (1) determining the initial pavement condition of each pavement segment; (2) determining the cost of construction and M&R activities over the life-cycle of each pavement segment; (3) determining the rate at which pavement condition deteriorates for each pavement segment given the pavement structure, traffic, environmental conditions, etc.; (4) determining the least life-cycle cost of construction and M&R activities for each pavement segment subject to each minimum acceptable pavement condition in the range; (5) for each minimum acceptable pavement condition in the range, adding up the least life-cycle costs for each pavement segment in the network, thereby calculating a network life-cycle cost corresponding to each minimum-n acceptable pavement condition in the range; (6) creating a trade-off curve showing the network life-cycle cost against the minimum acceptable pavement condition; (7) using the minimum acceptable pavement condition for the network at a pre-selected point on the trade-off curve to determine the construction and M&R activities for each pavement segment.

In a preferred embodiment, the state DOT decides on a method of evaluating pavement condition on each pavement segment within its jurisdiction, and determines the life-cycle and range of minimum acceptable pavement conditions. Each district of the state DOT has a common method for (1) evaluating the pavement condition for each pavement segment within its jurisdiction; (2) determining the cost of construction and M&R activities over the life-cycle of each pavement segment; (3) determining the rate at which pavement condition deteriorates for each pavement segment given the pavement structure, traffic, environmental conditions, etc.; (4) determining the least life-cycle cost of construction and M&R activities for each pavement segment subject to each minimum acceptable pavement condition in the range. For each minimum acceptable pavement condition in the range, each district adds up the least life-cycle costs for each pavement segment, thereby calculating a district-level total life-cycle cost for each minimum acceptable pavement condition in the range. Each district reports the resulting district trade-off curve to the central office of the state DOT. The state DOT adds up the costs for each district to obtain the overall trade-off curve for all the pavements within its jurisdiction. The central office then works with the decision makers to decide the appropriate point on the trade-off curve given the importance of pavement condition to the citizens of the state relative to other competing needs for public funds. The central office then reports the results of the trade-off decision, specifically the selected minimum acceptable pavement condition, to the districts for implementation of the corresponding construction and M&R activities. This process is repeated for each budget cycle, usually annually or biannually.

The preferred embodiment has the following advantages over the customary PMS method: (1) it separates the solution for the network into many solutions, one for each pavement segment; (2) there are many LCCA methods that can be used by the state DOT depending on its desired levels of sophistication, accuracy, complexity, cost, personnel, etc.; (3) the set of construction and M&R activities found using the invention correspond with the construction and M&R activities found using LCCA for each individual segment; (4) the LCCA for each pavement segment is distributed to the district level; (5) depending on the level of sophistication desired, only a limited amount of data on pavement condition, deteriorating rates, and costs must be maintained and kept current by the districts; and (5) the result of the invention is the selection of the preferred point on a trade-off curve between network pavement condition and costs.

### BRIEF DESCRIPTION OF THE DRAWINGS

For a better understanding of the present invention, reference is made to the below-referenced accompanying drawings, Reference numbers refer to the same or equivalent parts of the present invention throughout the several figures of the drawings.

FIG. 1 illustrates a method 100 for analyzing and minimizing the life-cycle cost of constructing, maintaining and rehabilitating a network of highway pavements in accordance with the present invention.

FIG. 2 illustrates a method 200 of calculating least life-cycle cost in accordance with the present invention.

FIG. 3 is a graphical plot of least life-cycle cost versus minimum acceptable pavement condition for a hypothetical pavement segment.

FIG. 4 is an example of a graphical plot of a trade-off curve showing network life-cycle cost against minimum acceptable pavement condition.

FIG. 5 illustrates a method 300 for analyzing and minimizing the life-cycle cost of constructing, maintaining and rehabilitating a set of objects in accordance with the present invention.

### MODES FOR CARRYING OUT THE INVENTION

The present invention is a system and method for analyzing and minimizing the life-cycle cost of constructing, maintaining and rehabilitating a network of highway pavements for a pre-determined life-cycle and associated range of minimum acceptable conditions thereof commonly referred to as a pavement management system (PMS). A further object of the invention is to provide a tool to enable a decision maker to realize the trade-off between cost and pavement condition, thereby aiding the decision maker in choosing an appropriate allocation of resources for pavement construction and M&R.

The life-cycle is pre-determined by the user of the present invention at the outset in accordance with the desired length of time for consideration. A longer life-cycle in inherently more speculative, as future changes in knowledge and technology cannot be accurately anticipated. However, a shorter life-cycle, while less speculative, results in a more limited perspective that may be less than ideal for the long ten. Thus, while the present invention is described in terms of a single pre-selected life-cycle, it is recognized that applying multiple life-cycles of both long and short duration is advisable, as the life-cycle selected will affect the results yielded by the present invention.

Also, the range of minimum acceptable pavement conditions for consideration is pre-determined by the user as desired. The range chosen may depend on a number of factors, such as budget, availability of data, desired level of specificity, relative importance of pavement upkeep, etc. This range represents the scope of pavement quality to be analyzed in accordance with the methods of the present invention. The range may comprise an incremental series of values (e.g. PSI=2.0 to 4.0 in increments of 0.1), or any other set of values as desired (e.g. PSI=2.0 to 3.0 in increments of 0.1, and 3.2 to 4.0 in increments of 0.2).

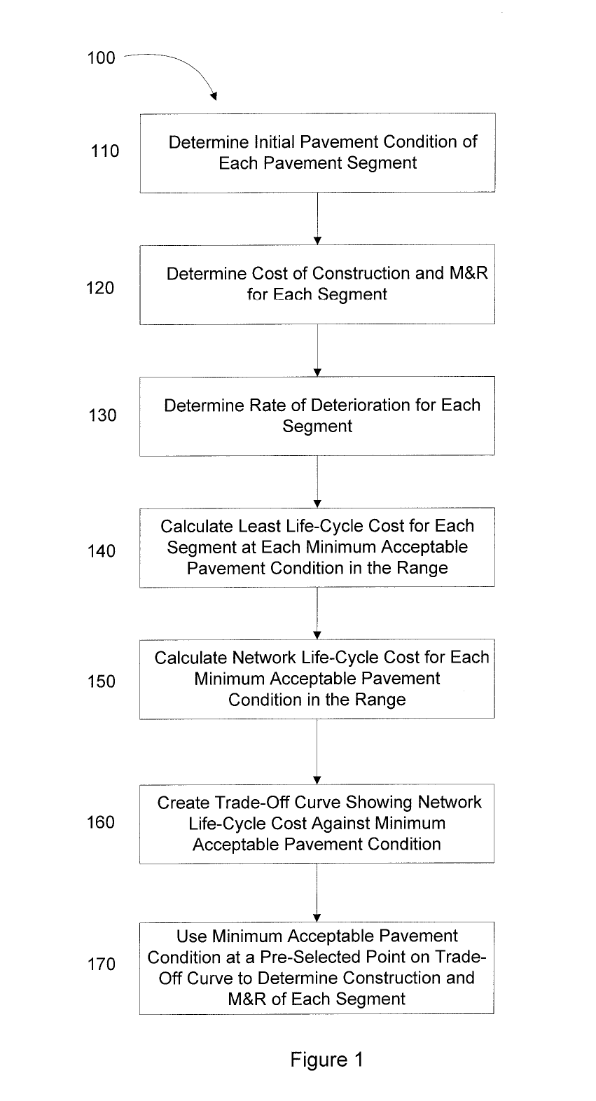

With reference to FIG. 1, an embodiment 100 of the method of the present invention is herein described in detail.

At step 110, the initial pavement condition is determined for each pavement segment in the network. Any of numerous systems and methods for assessing pavement condition that are well known in the art may be employed to calculate pavement condition. In arriving at a pavement condition rating, numerous measurements and factors can be taken into account, such as surface distress, structural capacity, roughness, skid resistance, noise and water spray. By way of example only, one system for assessing pavement condition is the Present Serviceability Index (PSI), rating pavements on a scale from 0 (worst) to 5 (best). Typically, new pavements are rated 4.5, whereas unacceptable pavements are rated below 2.0. PSI is used to gauge pavement roughness. Pavement roughness is considered the most important indicator of pavement condition by the using public, particularly on highways with speed limits higher than about 45 mph. The present embodiment is described in reference to the PSI rating system. It is understood, however, The present embodiment is described in reference to the PSI rating system. It is understood, however that for purposes of the present invention, any of various methods known in the art may be employed to determine pavement condition, so long as it provides an accurate scalar determination of pavement condition and is applied in a consistent manner to all pavement segments in the network.

Additionally, while the embodiment of the present invention is presently described in terms of PSI, which is a singular numerical measure of pavement quality, it is recognized that multiple measures of pavement quality may be applied. In such a case, then the methods of the present invention could be applied in parallel to each such measure.

At step 120, the cost of construction and M&R activities over the life-cycle of each pavement segment is determined. By way of example only, construction alternatives for asphalt pavements may include conventional hot mixed asphalt or rubberized asphalt concrete, while M&R activities for asphalt pavements may include crack filling, thin overlays, base repair and patching, structural overlays, or reconstruction. The scope of construction and M&R activities considered may be appropriately expanded or limited as necessary or desired, and may vary from one pavement segment type to another.

At step 130, the rate at which pavement condition deteriorates is determined for each pavement segment given the pavement structure, traffic, environmental conditions, etc. Systems and methods for determining the rate at which pavement condition deteriorates are well known in the art. For purposes of the present invention, any such system or method may be applied, so long as it provides accurate calculation of the rate of pavement condition deterioration, consistent with the chosen system and method for evaluating pavement condition.

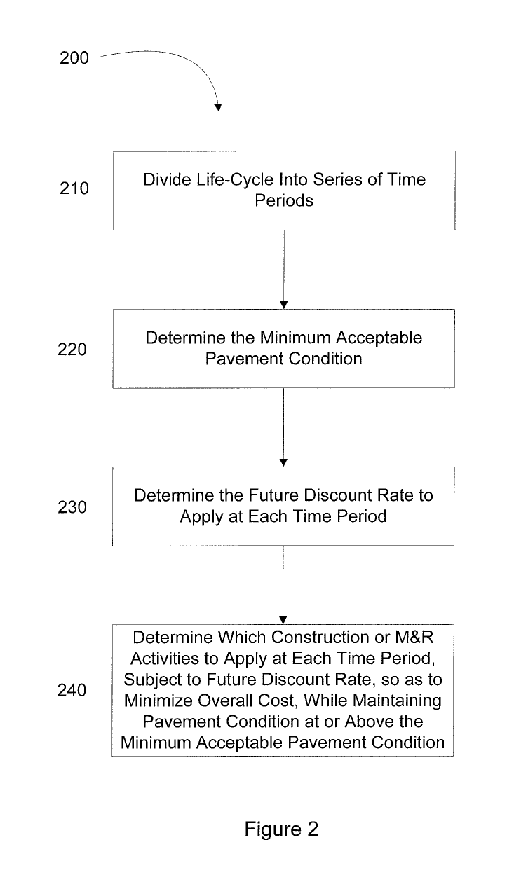

At step 140, the least life-cycle cost is calculated for each segment at each minimum acceptable pavement condition in the range. Numerous systems and methods for performing least life-cycle cost analysis are known in the art. With reference to FIG. 2, a method 200 of calculating least life-cycle cost involves the following steps: (210) dividing the life-cycle into a series of time periods; (220) determining the minimum acceptable pavement condition; (230) determining the future discount rate to apply at each time period, and (240) determining which construction or M&R activities (including the option of no activity) to apply at each time period so as to minimize overall cost, while maintaining the pavement condition at or above the minimum acceptable pavement condition. The foregoing method of calculating least life-cycle cost is provided by way of example only, as any of various methods known in the art may be applied in accordance with the present invention.

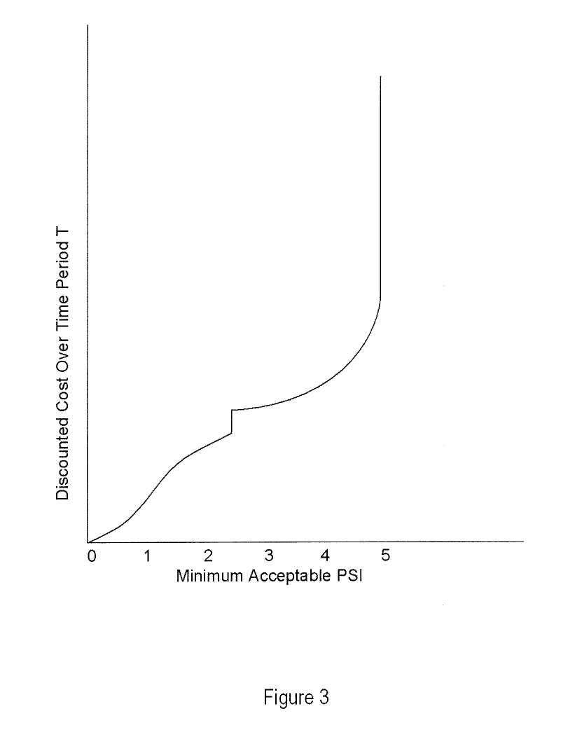

A graphical plot of least life-cycle cost versus minimum acceptable pavement condition (in units PSI) for a hypothetical pavement segment is illustrated in FIG. 3. The cost at PSI=0 is zero because it costs nothing to maintain a road with a PSI of 0. The cost at PSI=5 approaches infinity because attaining a PSI of 5 is, for all practical purposes, impossible. The relationship is monotonically increasing, perhaps with vertical steps. Vertical steps represent quantum changes in pavement technology, such as might be achieved with a change from asphalt to portland cement concrete.

At step 150, for each minimum acceptable pavement condition in the range, the least life-cycle costs for each pavement segment in the network are summed, thereby calculating a network life-cycle cost for each minimum acceptable pavement condition in the range.

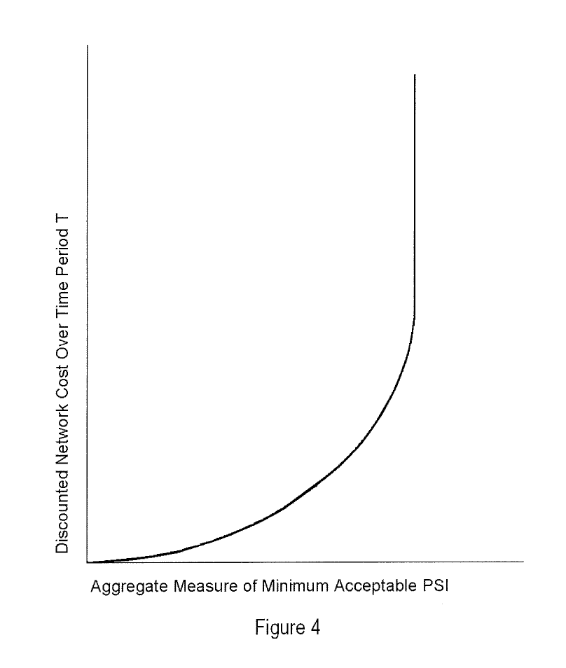

At step 160, a trade-off curve is created showing the network life-cycle cost against the minimum acceptable pavement condition. This depiction may take the form of a table, a graphical plot (as illustrated in FIG. 4), or some other form of visual representation. A decision maker would use the trade-off curve to aid in determining the proper allocation of resources to pavement construction and M&R. The decision maker would select an appropriate point on the trade-off curve given the importance of pavement condition relative to other competing needs for funds.

At step 170, the minimum acceptable pavement condition for the network at the selected point on the trade-off curve is used to determine the construction and M&R activities for each pavement segment.

In the foregoing embodiment, it is presumed that when determining network life-cycle cost, all pavement segments are subject to the same minimum acceptable pavement condition. However, it may be desirable to set different minimum acceptable pavement conditions for different types of pavement segments. For example, if while high speed highways are to be better maintained than city streets, one might set the minimum acceptable pavement condition of highways at some fixed value above the minimum acceptable pavement condition of city streets (e.g. PSI of highways=PSI of city streets+0.3). In the alternative, this value might be made variable depending on the level of minimum acceptable pavement condition being evaluated. For example, if the desired relationship is such that city streets vary between 2.0 and 4.0 while high speed highways vary between 3.0 and 4.0, then a relation could be set such that PSI of highways=PSI of city streets+(4−PSI of city streets)/2. Obviously, any relation, or none at all, could be applied for any number of categorizations of pavement.

Therefore, in an alternative embodiment of the present invention, pavement segments are separated into various types, each having a distinct range of minimum acceptable pavement condition. The minimum acceptable pavement condition

of a given pavement type may be independent, dependent on the minimum acceptable pavement condition of another pavement type, or dependent on an external variable. Each minimum acceptable pavement condition in a range for a particular type of pavement corresponds to a minimum acceptable pavement condition in the range for each of the other pavement types. The network life-cycle cost is calculated by summing the least life-cycle cost for all segments at their corresponding minimum acceptable pavement conditions. Thus, the network life-cycle cost reflects an aggregate measure of network pavement condition that correlates to, but is not necessarily equivalent to, the minimum acceptable pavement condition range of any particular pavement type. The network life-cycle cost is plotted against the aggregate network pavement condition (whose range and units may be chosen as desired), thereby yielding a cost-benefit curve that is useful for illustrating the trade-off between cost and overall pavement quality.

In a preferred embodiment of the present invention, the aforementioned methods are applied by a state DOT having both a central office and multiple districts. The state DOT determines appropriate methods to be applied, including the appropriate life-cycle and range of minimum acceptable pavement condition, so that each district of the state DOT has a common method for (1) evaluating the pavement condition for each pavement segment within its jurisdiction; (2) determining the cost of construction and M&R activities over the life-cycle of each pavement segment; (3) determining the rate at which pavement condition deteriorates for each pavement segment given the pavement structure, traffic, environmental conditions, etc.; (4) determining the least life-cycle cost of construction and M&R activities for each pavement segment subject to each minimum acceptable pavement condition in the range. For each minimum acceptable pavement condition in the range, each district adds up the least life-cycle costs for each pavement segment, thereby calculating a district-level total life-cycle cost for each minimum acceptable pavement condition in the range. Each district reports the resulting district trade-off curve to the central office of the state DOT. The state DOT adds up the costs for each district to obtain the overall trade-off curve for all the pavements within its jurisdiction. The central office then works with the decision makers to decide the appropriate point on the trade-off curve given the importance of pavement condition to the citizens of the state relative to other competing needs for public funds. The central office then reports the results of the trade-off decision, specifically the selected minimum acceptable pavement condition, to the districts for implementation of the corresponding construction and M&R activities. This process is repeated for each budget cycle, usually annually or biannually.

While the present invention has been described in terms of a network of pavement segments, it can be applied to any set of objects for which a condition can be defined, and for which the life-cycle cost of managing each member of the set is independent of the cost of maintaining any other member of the set. The present invention is thus easily adapted and applied to objects subject to wear and requiring M&R activities. The following examples are not intended to be limiting, but merely illustrate the breadth of objects for which the present invention may be applied: bridges, buildings, pipelines, electrical systems, sewage systems, fleets of vehicles (e.g. automobiles, locomotives, ships, aircraft), railways, runways, etc.

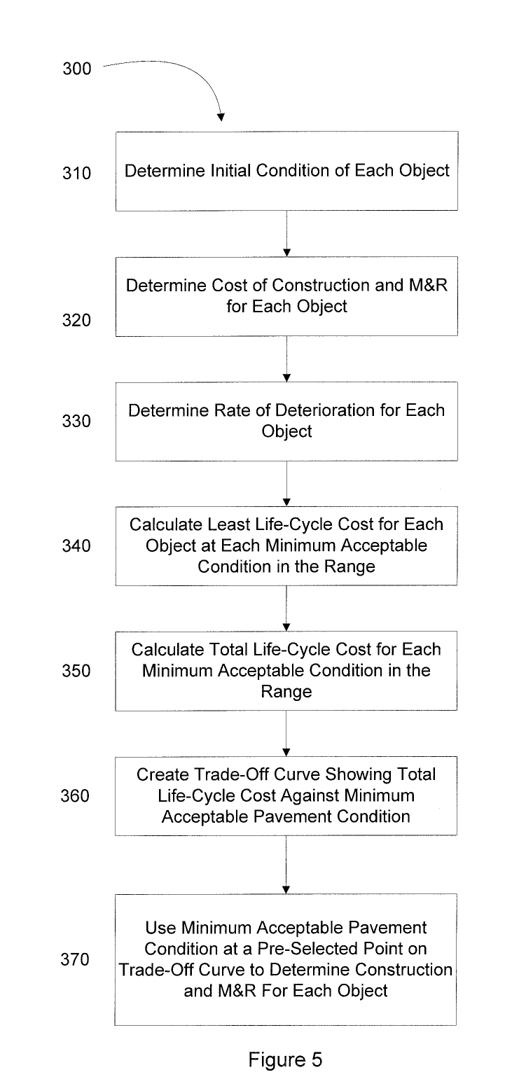

An alternative embodiment 300 of the present invention, as shown in FIG. 5, comprises a method of analyzing and minimizing the life-cycle cost of constructing, maintaining, and rehabilitating a set of objects for a predetermined life-cycle and associated range of minimum acceptable conditions thereof. The method comprises the following steps: (310) determining the initial condition of each object in the set; (320) determining the cost of construction and M&R activities over the life-cycle of each object in the set; (330) determining the rate at which the condition deteriorates for each object in the set; (340) determining the least life-cycle cost of construction and M&R activities for each object subject to each minimum acceptable condition in the range; (350) for each minimum acceptable condition in the range, adding up the least life-cycle costs for each object in the set, thereby calculating a total life-cycle cost corresponding to each minimum acceptable pavement condition in the range; (360) creating a trade-off curve showing the total life-cycle cost against the minimum acceptable condition; (370) using the minimum acceptable condition for the set of objects at a pre-selected point on the trade-off curve to determine the construction and M&R activities for each object.

In an alternative embodiment of the present invention, the foregoing methods of the present invention are performed under program control by a computer-based system. The program comprises instructions for executing the methods of the present invention, and may be embodied in both software and hardware, and stored in computer-readable media such as a disk, CD-ROM, hard drive, flash memory, RAM, etc. The program may be stored on a personal computer, a remote server, or be distributed across multiple networked computers/servers. In one embodiment, the program comprises instructions for analyzing the life-cycle cost of constructing, maintaining, and rehabilitating a set of objects for a pre-determined life-cycle and associated range of minimum acceptable conditions thereof. The program includes instructions for performing the following steps: (1) determining the initial condition of each object in the set; (2) determining the cost of construction and M&R activities over the life-cycle of each object in the set; (3) determining the rate at which the condition deteriorates for each object in the set; (4) determining the least life-cycle cost of construction and M&R activities for each object subject to each minimum acceptable condition in the range; (5) for each minimum acceptable condition in the range, adding up the least life-cycle costs for each object in the set, thereby calculating a total life-cycle cost corresponding to each minimum acceptable pavement condition in the range; (6) creating a trade-off curve showing the total life-cycle cost against the minimum acceptable condition; (7) using the minimum acceptable condition for the set of objects at a pre-selected point on the trade-off curve to determine the construction and M&R activities for each object. The program may receive user-inputted data for performing the aforementioned instructions. Furthermore, data may be received via a distributed network, enabling remotely located users to submit relevant data.

Information as herein shown and described in detail is fully capable of attaining the above-described object of the invention, the presently preferred embodiments of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural, electrical, and functional equivalents to the elements of the above-described preferred embodiment and additional embodiments that are known to those of ordinary skill in the art are expressly incorporated herein by reference and are intended to be encompassed by the present claims.

Moreover, it is not necessary for a device or method to address each and every problem sought to be solved by the present invention for it to be encompassed by the present claims. Furthermore, no element, component or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

### INDUSTRIAL APPLICABILITY

The present invention is industrially applicable to pavement management systems. The present invention is also applicable to objects requiring maintenance and rehabilitation activities for which a condition can be defined.

What is claimed is as follows:

1. A method for minimizing the life-cycle cost of constructing, maintaining and rehabilitating a network of highway pavements for a pre-determined life-cycle and associated range of minimum acceptable pavement conditions thereof, commonly referred to as a pavement management system, said method comprising;
determining an initial pavement condition for each pavement segment;
determining the cost of construction, maintenance and rehabilitation activities over the life-cycle of each pavement segment;
determining the rate at which pavement condition deteriorates for each pavement segment given the pavement structure, traffic, environmental conditions, etc.;
for each minimum acceptable pavement condition in the range, determining the least life-cycle cost of construction, maintenance and rehabilitation activities for each pavement segment;
for each minimum acceptable pavement condition in the range, determining a network life-cycle cost by adding tip the least life-cycle costs for each pavement segment in the network;
creating a trade-off curve showing the network life-cycle cost against the minimum acceptable pavement condition;
using the minimum acceptable pavement condition for the network at a pre-selected point on the trade-off curve to determine the construction and M&R activities for each pavement segment.

2. A software product comprising instructions stored on computer-readable media, wherein the instructions, when executed by a computer, perform steps for minimizing the life-cycle cost of constructing, rehabilitating and maintaining a network of highway pavements for a pre-determined life-cycle and associated range of minimum acceptable pavement conditions thereof commonly referred to as a pavement management system, said software product comprising:
instructions for determining the initial pavement condition of each pavement segment;
instructions for determining the cost of construction, maintenance and rehabilitation activities over the life-cycle of each pavement segment;
instructions for determining the rate at which pavement condition deteriorates for each pavement segment given the pavement structure, traffic, environmental conditions, etc.;
instructions for determining the least life-cycle cost of construction, maintenance and rehabilitation activities for each pavement segment subject to a given minimum acceptable pavement condition;
instructions for determining a network life-cycle cost for each minimum acceptable condition in the range, by adding up the least life-cycle costs for each object in the set;
instructions for creating a trade-off curve showing the total life-cycle cost of the network against the minimum acceptable pavement condition; and
instructions for using the minimum acceptable pavement condition for the network at a pre-selected point on the trade-off curve to determine the construction and M&R activities for each pavement segment.

3. A method for minimizing the life-cycle cost of constructing, maintaining and rehabilitating a set of objects for a pre-determined life-cycle and associated range of minimum acceptable conditions thereof, said method comprising:
determining the initial condition of each object in the set;
determining the cost of construction, maintenance and rehabilitation activities over the life-cycle of each object in the set;
determining the rate at which condition deteriorates for each object in the set;
for each minimum acceptable condition in the range, determining the least life-cycle cost of construction, maintenance and rehabilitation activities for each object;
for each minimum acceptable condition in the range, determining a total life-cycle cost by adding up the least life-cycle costs for each object in the set;
creating a trade-off curve showing the total life-cycle cost against the minimum acceptable condition;
using the minimum acceptable condition for the set of objects at a pre-selected point on the trade-off curve to determine the construction and M&R activities for each object.
